(19) United States
(12) Patent Application Publication
(10) Pub. No.: US 2020/0366157 A1
(43) Pub. Date: Nov. 19, 2020

(54) VOICE COIL MOTOR WITH THE BUFFERING EFFECT

(71) Applicant: CONCRAFT HOLDING CO., LTD., Grand Cayman (KY)

(72) Inventors: Lin LIU, Kunshan City (CN); Jun ZHAO, Kunshan City (CN); Heng YANG, Kunshan City (CN)

(21) Appl. No.: 16/539,274

(22) Filed: Aug. 13, 2019

(30) Foreign Application Priority Data
May 17, 2019 (TW) 108117113

(51) Int. Cl. H02K 5/24; H02K 41/035; G02B 7/02

(52) U.S. Cl. CPC H02K 5/24; G02B 7/023; H02K 41/0356

(57) ABSTRACT

A voice coil motor with the buffering effect is used to carry a lens, including a frame which is provided with a first abutting surface and a second abutting surface, a movable support which is disposed in the frame to move in reciprocation, a first cushion which is disposed between the movable support and the first abutting surface, and a second cushion which is disposed between the movable support and the second abutting surface. The movable support is provided with a first position toward the first abutting surface, and a second position toward the second abutting surface. When the movable support undergoes the reciprocation motion between the first position and the second position, collision between the movable support and the frame is mitigated through the first cushion and the second cushion.

### BACKGROUND OF THE INVENTION

### a) Field of the Invention

The present invention relates to a voice coil motor, and more particularly to a voice coil motor which is used to carry a lens and is able to effectively mitigate collision resulted from operation, thereby extending the lifetime of use.

### b) Description of the Prior Art

A voice coil motor is used primarily in a mobile device, such as digital camera, digital V8, smart phone, tablet personal computer or laptop computer. The voice coil motor is provided with the advantages of small size, low price, and less electricity consumption. The voice coil motor carries a micro lens, and when being energized, the voice coil motor can drive the micro lens to achieve the zooming effect to the micro lens, through a magnet and an induction coil by the excitation effect.

A Taiwanese Invention Patent Publication No. 1265668 discloses an axial actuating device with an elastic connecting part, including a fixed part, a movable part and a connecting part. The connecting part is used to combine the fixed part and the movable part, and enables the fixed part to be connected with the movable part axially. On the other hand, the fixed part is a fixed magnet and the movable part is a coil, so that when a current is applied to the movable part, a relative displacement can be formed between the movable part and the fixed part in accordance with the magnitude of current, which achieves the object of providing an axial displacement. In addition, as the energy of motion results from the repulsive force of magnetic field, the invention is also provided with the shock-proof effect.

When the movable part results in an axial displacement inside the fixed part, the connecting part is used to limit the displacement of the movable part.

On the other hand, Taiwanese Patent Publications Nos. 1437796 and 1410733 disclose respectively a spring plate and a voice coil motor having the spring plate, as well as a lens actuating device, a shock-absorption spring plate and a manufacturing method thereof. In these patents, a spring plate is commonly used to limit the movable part and to provide the buffering effect.

When the abovementioned movable part is moving axially, the movable part can be limited and buffered through the connecting part (or spring plate). However, when moving to an upper or lower limiting position, the movable part will collide with a housing easily. For existing voice coil motors, most of the movable parts are formed by injection molding to a plastic material, and most of the housings are made of a metallic or plastic material. Therefore, when the movable part moves to the upper or lower limiting position, collision between the movable part and the housing can be formed easily, thereby resulting in fragments from the movable part or the housing through the long-term collision. These fragments will remain between the fixed part and the movable part, which can cause the damage to the voice coil motor easily to shorten the lifetime of use of the voice coil motor, after a long time of use.

Accordingly, how to provide a voice coil motor that is provided with the buffering effect and is able to extend the lifetime of use, is the issue to be solved by the present invention.

### SUMMARY OF THE INVENTION

The primary object of the present inventor provides a voice coil motor, and more particularly to a voice coil motor which is used to carry a lens and is able to effectively mitigate collision resulted from operation, thereby extending the lifetime of use.

To achieve the abovementioned object, the present invention first provides a voice coil motor with the buffering effect. The voice coil motor is used to carry a lens, comprising a frame, a movable support which is disposed in a moving space and can move in reciprocation, a first cushion and a second cushion. The frame is provided with the moving space, and the moving space is provided with a first abutting surface and a second abutting surface which is opposite to the first abutting surface. The movable support is provided with an installation hole to carry the lens, and is provided with a first surface which is in adjacent and opposite to the first abutting surface, as well as a second surface which is in adjacent and opposite to the second abutting surface. In addition, the movable support is provided in the moving space with a first position which is abutted toward the first abutting surface, and a second position which is abutted toward the second abutting surface, forming a reciprocating motion between the first position and the second position. The first cushion is disposed on the first abutting surface, and when the movable support is at the first position, the first surface will be in touch with the first cushion. The second cushion is disposed on the second abutting surface, and when the movable support is at the second position, the second surface will be in touch with the second cushion. Therefore, when the movable support undergoes the reciprocating motion between the first position and the second position, the collision between the movable support and the frame is mitigated through the first cushion and the second cushion.

In an embodiment, the first cushion and the second cushion are made of silica gel or anti-vibration rubber.

In an embodiment, the first cushion and the second cushion are directly formed on the first abutting surface and the second abutting surface respectively, by injection molding.

In an embodiment, the movable support is further provided with a top surface in the direction of first surface, and the top surface is protruded at least with a first convex part toward the first abutting surface, with the first surface being disposed on the first convex part.

In an embodiment, the movable support is further provided with a bottom surface in the direction of second surface, and the bottom surface is protruded at least with a second convex part toward the second abutting surface, with the second surface being disposed on the second convex part.

To achieve the abovementioned object, the present invention provides another voice coil motor with the buffering effect. The voice coil motor is used to carry a lens, comprising a frame, a movable support which is disposed in a moving space and can move in reciprocation, a first cushion and a second cushion. The frame is provided with the moving space, and the moving space is provided with a first abutting surface and a second abutting surface which is opposite to the first abutting surface. The movable support is provided with an installation hole to carry the lens, and is provided with a first surface which is in adjacent and opposite to the first abutting surface, as well as a second surface which is in adjacent and opposite to the second abutting surface. In addition, the movable support is provided in the moving space with a first position which is abutted toward the first abutting surface, and a second position which is abutted toward the second abutting surface, forming a reciprocating motion between the first position and the second position. The first cushion is disposed on the first surface, and when the movable support is at the first position, the first abutting surface will be in touch with the first cushion. The second cushion is disposed on the second surface, and when the movable support is at the second position, the second abutting surface will be in touch with the second cushion. Therefore, when the movable support undergoes the reciprocating motion between the first position and the second position, the collision between the movable support and the frame is mitigated through the first cushion and the second cushion.

In an embodiment, the first cushion and the second cushion are made of silica gel or anti-vibration rubber.

In an embodiment, the first cushion and the second cushion are directly formed on the first surface and the second surface respectively, by injection molding.

In an embodiment, the movable support is further provided with a top surface in the direction of first surface, and the top surface is protruded at least with a first convex part toward the first abutting surface, with the first surface being disposed on the first convex part.

In an embodiment, the movable support is further provided with a bottom surface in the direction of second surface, and the bottom surface is protruded at least with a second convex part toward the second abutting surface, with the second surface being disposed on the second convex part.

In comparison with the prior arts, the voice coil motor of the present invention is provided with the following advantages.

When the movable support undergoes the reciprocating motion in the frame through the first position and the second position, the collision between the movable support and the frame can be mitigated through the first cushion and the second cushion, thereby reducing the fragments, dust or stain from the collision between the movable support and the frame to extend the lifetime of use.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a first mode of present invention.

FIG. 2 shows a three-dimensional exploded view at a first viewing angle of the first mode of present invention.

FIG. 3 shows a three-dimensional exploded view at a third viewing angle of the first mode of present invention.

FIG. 4 shows a cutaway view of the first mode of present invention.

FIG. 5 shows a cutaway view of the first mode of present invention, wherein a movable support is at a first position.

FIG. 6 shows a cutaway view of the first mode of present invention, wherein the movable support is at a second position.

FIG. 7 shows a three-dimensional exploded view at a first viewing angle of a second mode of present invention.

FIG. 8 shows a three-dimensional exploded view at a third viewing angle of the second mode of present invention.

FIG. 9 shows a cutaway view of the second mode of present invention.

FIG. 10 shows a cutaway view of the second mode of present invention, wherein the movable support is at the first position.

FIG. 11 shows a cutaway view of the second mode of present invention, wherein the movable support is at the second position.

### DETAILED DESCRIPTION OF THE PREFERRED EMBODIMENTS

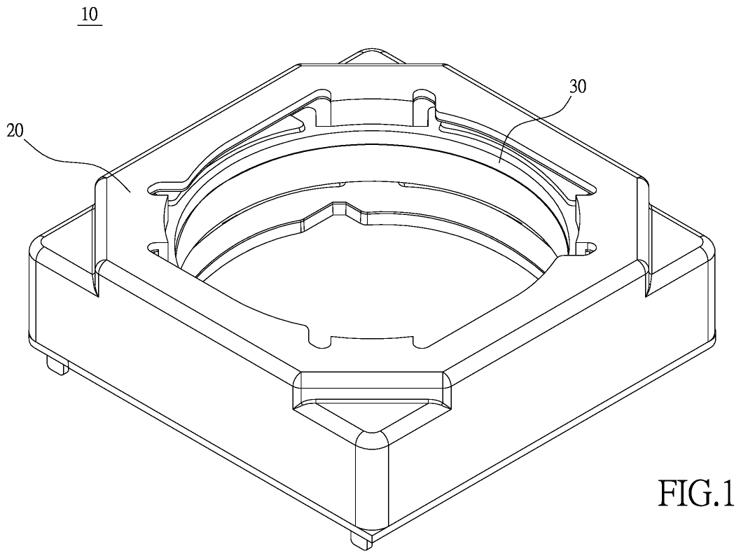

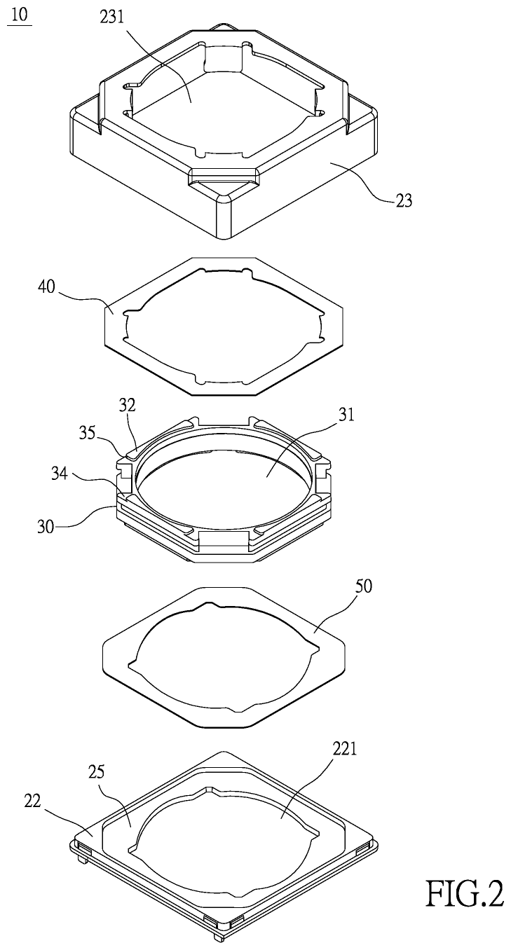

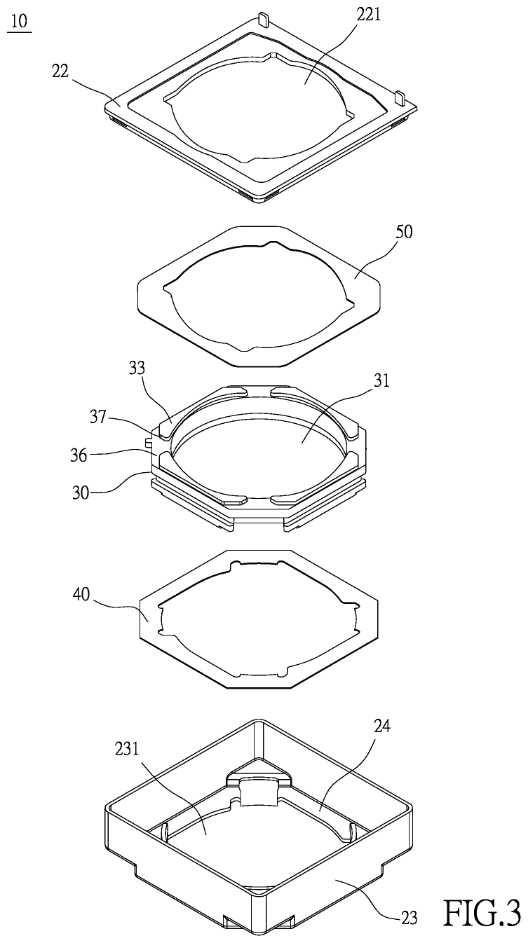

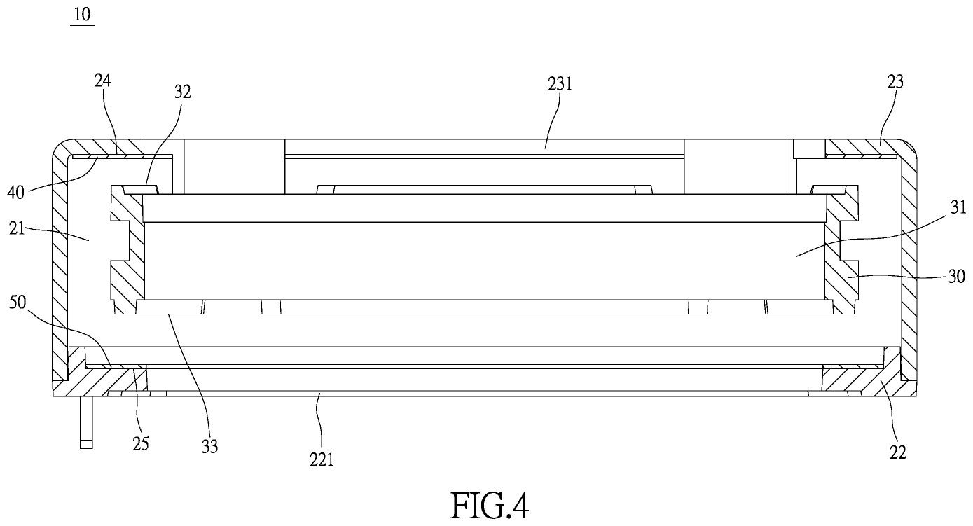

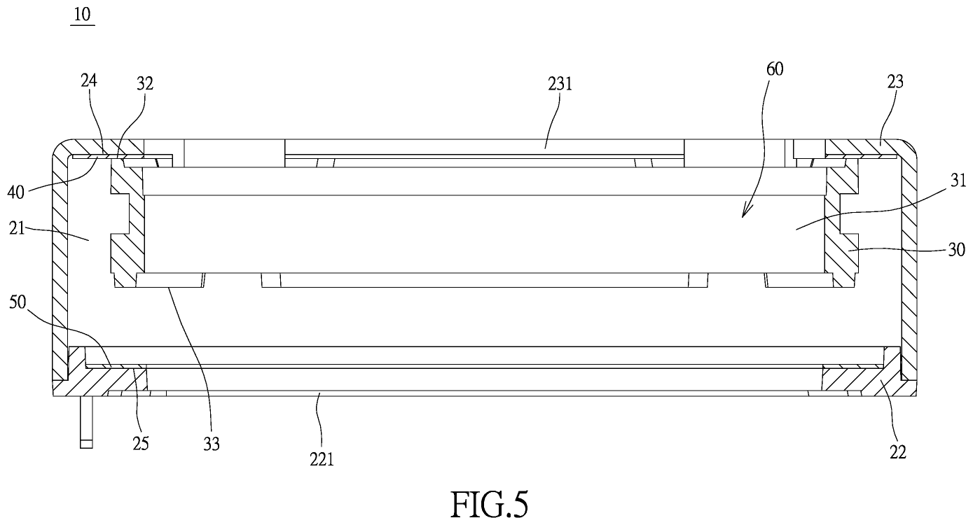

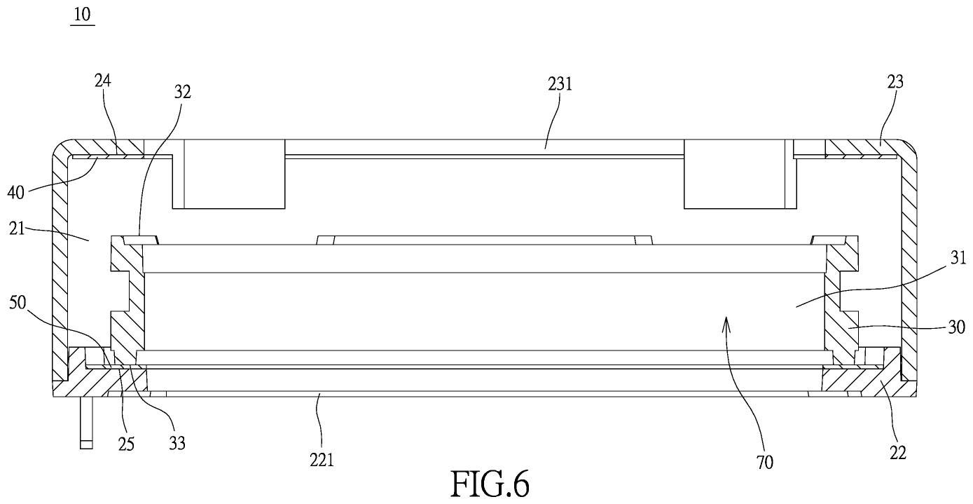

Referring to FIGS. 1 to 6, the present invention discloses a voice coil motor with the buffering effect. The voice coil motor 10 is used to carry a lens (not shown in the drawings, as it is a prior art), and comprises a frame 20, a movable support 30, a first cushion 40 and a second cushion 50.

An interior of the frame 20 is provided with a moving space 21 which is formed by a bottom seat 22 and a cover 23. The cover 23 is formed with a first abutting surface 24 inside the moving space 21, and the bottom seat 22 is provided in the moving space 21 with a second abutting surface 25 which is opposite to the first abutting surface 24. In the present embodiment, a center location of the cover 23 is provided with a clear opening 231 which is connected with the moving space 21; whereas, the bottom seat 22 is also provided with a through-hole 221 which is connected with the moving space 21, with the clear opening 231 and the through-hole 221 being disposed on a same axis.

The movable support 30 is disposed in the moving space 21 of the frame 20, and is provided with an installation hole 31 to carry the lens. The installation hole 31 is disposed on a same axis as that of the clear opening 231 and the through-hole 221, and an exterior of the movable support 30 can provide for the disposition of an induction coil (not shown in the drawings, as it is a prior art) along the extension direction of the installation hole 31. In addition, a first surface 32 is disposed on the movable support 30 along the extension direction of the installation hole 31 and in adjacent to the first abutting surface 24; whereas, a second surface 33 is located in adjacent to the second abutting surface 25. The first surface 32 is in adjacent and opposite to the first abutting surface 24, and the second surface 33 is in adjacent and opposite to the second abutting surface 25. The movable support 30 is formed with a top surface 34 in the direction of the first surface 32, and the top surface 34 is protruded at least with a first convex part 35 toward the first abutting surface 24, with the first surface 32 being disposed on the first convex part 35. The movable support 30 is formed with a bottom surface 36 in the direction of the second surface 33, and the bottom surface 36 is protruded at least with a second convex part 37 toward the second abutting surface 25, with the second surface 33 being disposed on the second convex part 37. In the present embodiment, the top surface 34 is protruded with four first convex parts 35, and the bottom surface 36 is also protruded with four second convex parts 37; whereas, each first convex part 35 is formed with one first surface 32, and each second convex part 37 is formed with one second surface 33.

The first cushion 40 is disposed between the first abutting surface 24 and the first surface 32. In the present embodiment, the first cushion 40 is disposed on the first abutting surface 24, and is made of silica gel. The first cushion 40 is formed primarily by injection molding. The cover 23 is first emplaced in a first mold (not shown in the drawings) to expose the first abutting surface 24 in a first forming space in the first mold, and next a liquid form of silica gel is injected into the first forming space. When the liquid form of silica gel is cooled down and solidified in the first forming space, the first cushion 40 can be formed on the first abutting surface 24.

The second cushion 50 is disposed between the second abutting surface 25 and the second surface 33. In the present embodiment, the second cushion 50 is disposed on the second abutting surface 25, and is also made of silica gel. The second cushion 50 is formed by injection molding as well. The bottom seat 22 is first emplaced in a second mold (not shown in the drawings) to expose the second abutting surface 25 in a second forming space in the second mold, and next a liquid form of silica gel is injected into the second forming space. When the liquid form of silica gel is cooled down and solidified in the second forming space, the second cushion 50 can be formed on the second abutting surface 25.

Furthermore, in addition to that the first cushion 40 and the second cushion 50 can be formed by silica gel, they can also be made of other shock-absorption material such as anti-vibration rubber.

When the voice coil motor 10 of the present invention is applied to a camera module of the abovementioned mobile device, the induction coil can be driven by excitation after energizing the circuit, enabling the movable support 30 to result in a reciprocating motion in the moving space 21, which drives in turn the lens to displace in the frame 20 to achieve the zooming effect. On the other hand, when the movable support 30 undergoes the reciprocating motion, a first position 60 will be formed at a location in adjacent to the first abutting surface 24, and a second position 70 will be formed at a location in adjacent to the second abutting surface 25, enabling the movable support 30 to form a reciprocating motion between the first position 60 and the second position 70.

When the movable support 30 moves toward the first position 60, the first surface 32 on the movable support 30 will displace toward the first abutting surface 24, allowing the first surface 32 to be abutted on the first cushion 40. On the other hand, when the movable support 30 moves from the first position 60 to the second position 70, the second surface 33 will displace toward the second abutting surface 25, allowing the second surface 33 to be abutted on the second cushion 50. Accordingly, when the movable support 30 results in the reciprocating motion between the first position 60 and the second position 70, collision between the first surface 32 and the first abutting surface 24 can be avoided through the first cushion 40, and collision between the second surface 33 and the second abutting surface 25 can be avoided through the second cushion 50, which in turn buffers the collision between the first surface 32 and the first abutting surface 24 as well as between the second surface 33 and the second abutting surface 25, through the first cushion 40 and the second cushion 50. In addition, fragments, dust or stain from the collision between the first surface 32 and the first abutting surface 24 as well as between the second surface 33 and the second abutting surface 25 can be reduced, thereby extending the lifetime of use of the voice coil motor 10 effectively.

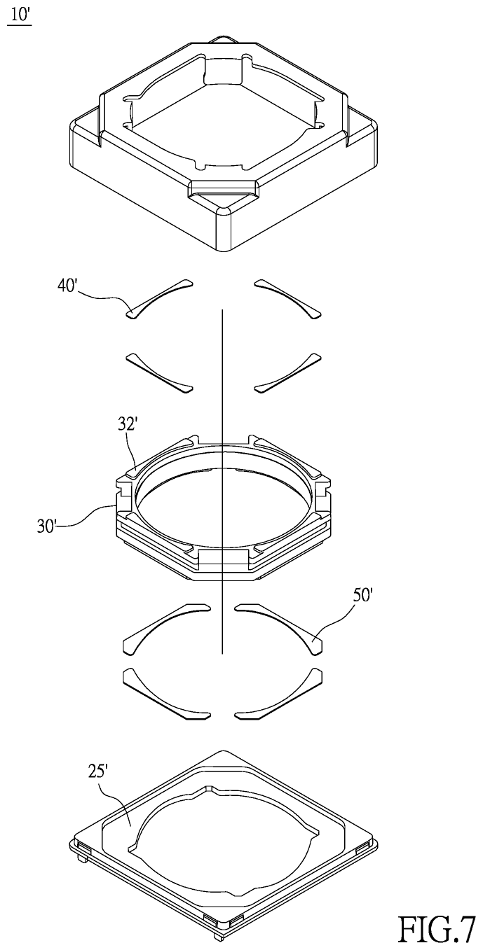

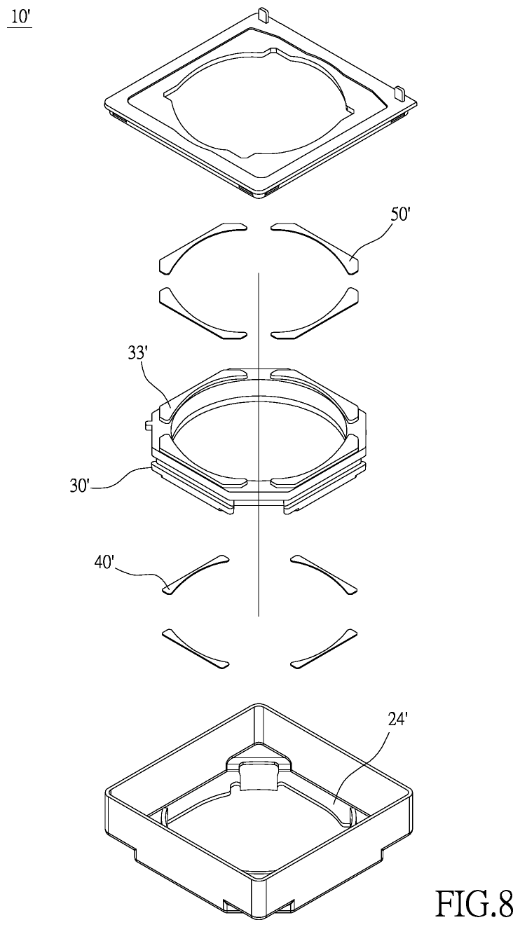

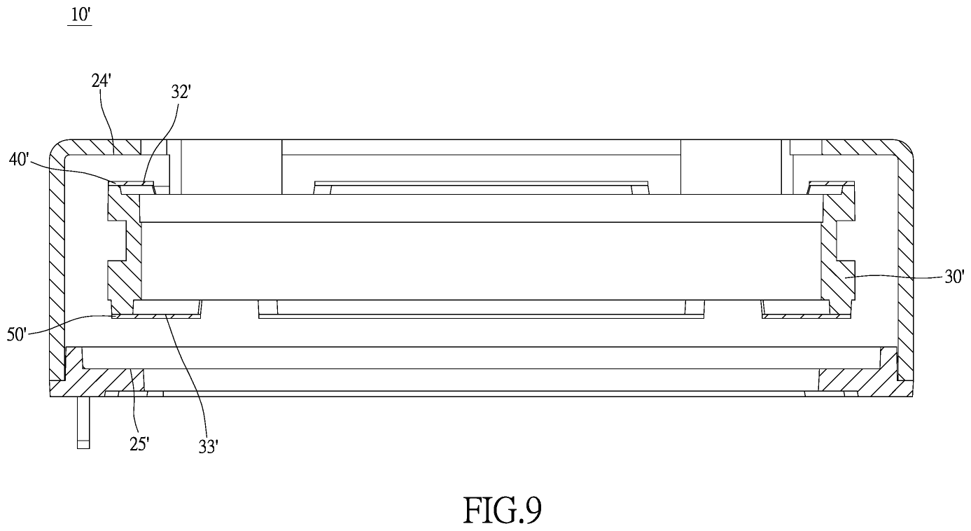

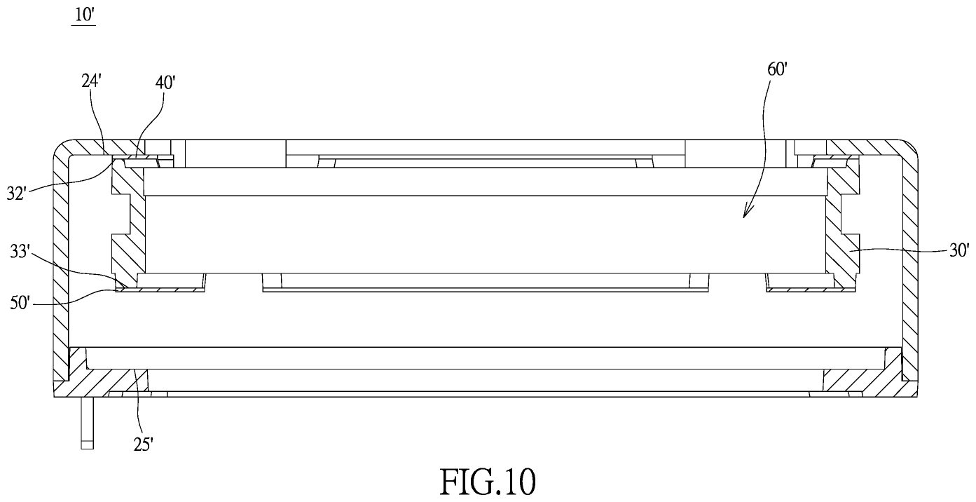

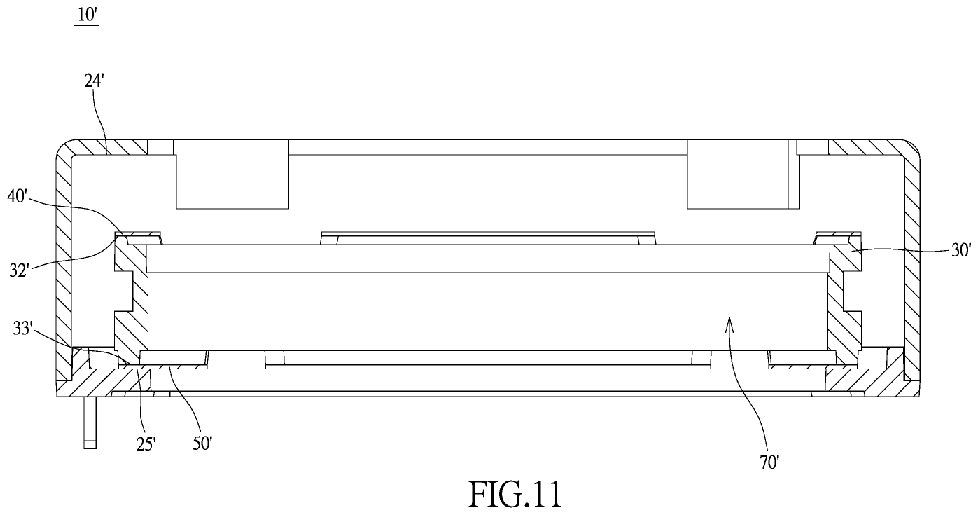

Moreover, referring to FIGS. 7 to 11, it shows a second mode of the voice coil motor 10′ of the present invention. In the present embodiment, the first cushion 40′ is disposed on the first surface 32′, and the second cushion 50′ is disposed on the second surface 33′, wherein the first cushion 40′ and the second cushion 50′ are formed directly on the first surface 32′ and the second surface 33′ by injection molding, respectively. In the forming method, the movable support 30′ is emplaced in a third mold (not shown in the drawings), and the first surface 32′ and the second surface 33′ are exposed at a same time in a third forming space and a fourth forming space in the third mold. Next, a liquid form of silica gel is injected into the third forming space and the fourth forming space at a same time. When the liquid form of silica gel is cooled down and solidified in the third forming space and the fourth forming space, the first cushion 40′ can be formed directly on the first surface 32′, and the second cushion 50′ can be formed directly on the second surface 33′.

In the present embodiment, the first cushion 40′ is divided into four sections, and each section is formed on one corresponding first surface 32′. The second cushion 50′ is also divided into four sections, and each section is formed on one corresponding second surface 33′. Accordingly, when the movable support 30′ is located at the first position 60′, the first cushion 40′ on the first surface 32′ will be abutted with the first abutting surface 24′; whereas, when the movable support 30′ is located at the second position 70′, the second cushion 50′ on the second surface 33′ will be abutted with the second abutting surface 25′.

Therefore, when the movable support 30′ results in the reciprocating motion between the first position 60′ and the second position 70′, the collision between the first surface 32′ and the first abutting surface 24′ can be similarly avoided through the first cushion 40′, and the collision between the second surface 33′ and the second abutting surface 25′ can be similarly avoided through the second cushion 50′, which in turn buffers the collision between the first surface 32′ and the first abutting surface 24′ as well as between the second surface 33′ and the second abutting surface 25′ through the first cushion 40′ and the second cushion 50′. In addition, the fragments, dust or stain from the collision between the first surface 32′ and the first abutting surface 24′ as well as between the second surface 33′ and the second abutting surface 25′ can be also reduced, thereby extending the lifetime of use of the voice coil motor 10′ effectively.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A voice coil motor with the buffering effect, which is used to carry a lens, comprising
a frame, an interior of which is provided with a moving space, with the moving space being provided with a first abutting surface and a second abutting surface opposite to the first abutting surface;
a movable support which is disposed in the moving space to move in reciprocation, with an interior of movable support being provided with an installation hole to carry a lens, the movable support being provided with a first surface in adjacent and opposite to the first abutting surface as well as a second surface in adjacent and opposite to the second abutting surface, and the movable support being provided in the moving space with a first position abutted toward the first abutting surface and a second position abutted toward the second abutting surface, allowing the movable support to result in the reciprocation motion between the first position and the second position;
a first cushion which is disposed on the first abutting surface, such that when the movable support is located at the first position, the first surface is in touch with the first cushion; and
a second cushion which is disposed on the second abutting surface, such that when the movable support is located at the second position, the second surface is in touch with the second cushion.

2. The voice coil motor with the buffering effect, according to claim 1, wherein the first cushion and the second cushion are made of silica gel or anti-vibration rubber.

3. The voice coil motor with the buffering effect, according to claim 2, wherein the first cushion and the second cushion are formed directly on the first abutting surface and the second abutting surface respectively, by injection molding.

4. The voice coil motor with the buffering effect, according to claim 1, wherein the movable support is further provided with a top surface in the direction of the first surface, and the top surface is protruded with a first convex part toward the first abutting surface, with the first surface being disposed on the first convex part.

5. The voice coil motor with the buffering effect, according to claim 1, wherein the movable support is further provided with a bottom surface in the direction of the second surface, and the bottom surface is protruded with a second convex part toward the second abutting surface, with the second surface being disposed on the second convex part.

6. A voice coil motor with the buffering effect, which is used to carry a lens, comprising
a frame, an interior of which is provided with a moving space, with the moving space being provided with a first abutting surface and a second abutting surface opposite to the first abutting surface;
a movable support which is disposed in the moving space to move in reciprocation, with an interior of movable support being provided with an installation hole to carry a lens, the movable support being provided with a first surface in adjacent and opposite to the first abutting surface as well as a second surface in adjacent and opposite to the second abutting surface, and the movable support being provided in the moving space with a first position abutted toward the first abutting surface and a second position abutted toward the second abutting surface, allowing the movable support to result in the reciprocation motion between the first position and the second position;
a first cushion which is disposed on the first surface, such that when the movable support is located at the first position, the first abutting surface is in touch with the first cushion; and
a second cushion which is disposed on the second surface, such that when the movable support is located at the second position, the second abutting surface is in touch with the second cushion.

7. The voice coil motor with the buffering effect, according to claim 6, wherein the first cushion and the second cushion are made of silica gel or anti-vibration rubber.

8. The voice coil motor with the buffering effect, according to claim 7, wherein the first cushion and the second cushion are formed directly on the first surface and the second surface respectively, by injection molding.

9. The voice coil motor with the buffering effect, according to claim 6, wherein the movable support is further provided with a top surface in the direction of the first surface, and the top surface is protruded with a first convex part toward the first abutting surface, with the first surface being disposed on the first convex part.

10. The voice coil motor with the buffering effect, according to claim 6, wherein the movable support is further provided with a bottom surface in the direction of the second surface, and the bottom surface is protruded with a second convex part toward the second abutting surface, with the second surface being disposed on the second convex part.
